(19) United States
(12) Patent Application Publication
(10) Pub. No.: US 2025/0376049 A1
(43) Pub. Date: Dec. 11, 2025

(54) ELECTRIC VEHICLE CHARGING APPARATUS AND METHOD

(71) Applicants: Hyundai Motor Company, Seoul (KR); Kia Corporation, Seoul (KR)

(72) Inventors: Jin-Su Jang, Hwaseong-si (KR); Moon-Kyung Joo, Hwaseong-si (KR)

(21) Appl. No.: 18/945,081

(22) Filed: Nov. 12, 2024

(30) Foreign Application Priority Data
Jun. 10, 2024 (KR) 10-2024-0074949

(51) Int. Cl. B60L 53/10; B60L 53/22; B60L 53/35

(52) U.S. Cl. CPC B60L 53/11; B60L 53/22; B60L 53/35; B60L 2210/30; B60L 2210/40

(57) ABSTRACT

An electric vehicle charging apparatus of an automatic connection type can be efficiently applied to a manual connection type. Such electric vehicle charging apparatus can include a Y junction box configured to provide a connection between at least one of charging lines of a manual connection type and at least one of charging lines of an automatic connection type, a junction box configured to receive a DC output of the Y junction box, and an on-board charger configured to receive an AC output of the Y junction box.

### CROSS-REFERENCE TO RELATED APPLICATIONS

This application claims the benefit of Korean Patent Application No. 10-2024-0074949, filed on Jun. 10, 2024, which application is hereby incorporated herein by reference.

### TECHNICAL FIELD

The present disclosure relates to an electric vehicle charging technology.

### BACKGROUND

Currently, electric vehicle charging in North America may be largely classified into a combined charging system (CCS) type and a North American charging standard (NACS) type. The CCS type supports standards, such as Society of Automotive Engineers (SAE) J1772, International Electrotechnical Commission (IEC) 62196, IEC 61815, and International Organization for Standardization (ISO) 15118, and enables AC/DC charging based on high-level communication between vehicles and chargers.

In the case of Tesla, its own charging connector and communication specifications have been developed and operated, and an independent charging infrastructure such as a supercharger network has been established.

However, all of the electric vehicle charging methods are methods of directly connecting a charger cable to a vehicle, and as the charging capacity gradually increases, a weight of the charging cable increases, resulting in a safety issue. In addition, when autonomous driving-based unmanned vehicles are introduced in the future, charging using a manual connection type that requires a person to directly connect a charging cable to a charging connector is not possible.

Meanwhile, an automatic connection device (ACD) technology for electric vehicle charging has been introduced, and the ACD is a device that automatically connects an existing charging port to a charger without person intervention by coupling an existing charging port to a robot. The ACD provides conductive charging just like the existing charging port, but charging connection is possible through an automated robot instead of a person.

However, to adopt such an ACD technology, a new ACD interface needs to be provided separately from an interface of an existing manual connection type, which is inevitably burdensome additional cost when the interface of the manual connection type is already provided.

Therefore, there is a need for a charging technology of a new automatic connection type, which can be efficiently applied to the already widely used manual connection type.

Korean Patent Application Laid-Open No. 10-2022-0159890 and Korean Patent Application Laid-Open No. 10-2022-0138635 disclose subject matter related to subject matter disclosed herein.

### SUMMARY

The present disclosure relates to an electric vehicle charging technology, and more specifically, to an electric vehicle charging apparatus and method to which an automatic connection type is applied.

An embodiment of the present disclosure can solve the problems according to the related art and can be directed to allowing an automatic connection type such as an automatic connection device-underbody (ACD-U) to be efficiently applied to an already widely used manual connection type so that a vehicle may be charged by itself without person intervention.

An embodiment of the present disclosure can provide a vehicle charging apparatus and method using an automatic connection type, which can secure compatibility with an existing charging infrastructure by using interchangeably the existing combined charging system (CCS) and North American charging standard (NACS) types.

An embodiment of the present disclosure can provide a vehicle charging apparatus and method capable of performing charging by distinguishing AC/DC charging methods even when an automatic charging connection method is applied.

An embodiment of the present disclosure can provide an electric vehicle charging apparatus using an automatic connection type that may be efficiently applied to a manual connection type.

An electric vehicle charging apparatus can include a Y junction box configured to provide a connection between at least one of charging lines of a manual connection type and at least one of charging lines of an automatic connection type, a junction box configured to receive a DC output of the Y junction box, and an on-board charger configured to receive an AC output of the Y junction box.

The automatic connection type may be an automatic connection device-underbody (ACD-U) type.

The Y junction box may include a DC Y junction box configured to provide the DC output, and an AC Y junction box configured to provide the AC output.

The electric vehicle charging apparatus may further include a charge controller configured to perform charging control using one or more of DC charging or AC charging.

The electric vehicle charging apparatus may further include a battery charged using one or more of the DC charging or the AC charging. In this case, the junction box may perform the DC charging using the DC output, and the on-board charger may generate a DC output for charging for charging the battery using the AC output for AC charging.

The junction box and the on-board charger may each include at least one relay, and during the DC charging, a relay of the junction box may be closed and a relay of the on-board charger may be open, and during the AC charging, the relay of the junction box may be open and the relay of the on-board charger may be closed.

The relay of the junction box and the relay of the on-board charger may maintain an open state when not charging (during non-charging).

The charging lines of the manual connection type may include an L1 line, an N line, a DC-line, and a DC+line that correspond to a combined charging system 1 (CCS 1), and the Y junction box may connect the L1 line to an L1 line of the ACD-U type, connect the N line to an N line of the ACD-U type, connect the DC-line to a DC-line of the ACD-U type, and connect the DC+ line to a DC+ line of the ACD-U type.

The charging lines of the manual connection type may include an L1 line, an L2 line, an L3 line, an N line, a DC-line, and a DC+line that correspond to a combined charging system 2 (CCS 2), and the Y junction box may connect the L1 line to an L1 line of the ACD-U type, may connect the L2 line to an L2 line of the ACD-U type, may connect the L3 line to an L3 line of the ACD-U type, may connect the N line to an N line of the ACD-U type, may connect the DC-line to a DC-line of the ACD-U type, and may connect the DC+ line to a DC+ line of the ACD-U type.

The charging lines of the manual connection type may include an L1 line and an N line that correspond to a North American charging standard (NACS), and the Y junction box may connect the L1 line to DC+/L1 lines of the ACD-U type and connect the N line to DC-/N lines of the ACD-U type.

An embodiment of the present disclosure can provide an electric vehicle charging method including determining, by a charge controller, whether it is DC charging or AC charging when docking of an automatic connection type is completed, and performing, by the charge controller, DC charging of a battery by closing one or more relays of a junction box receiving a DC output of a Y junction box and opening one or more relays of an on-board charger receiving an AC output of the Y junction box, when it is determined to be the DC charging.

The electric vehicle charging method may further include, by the charge controller, performing AC charging of the battery by opening the one or more relays of the junction box and closing the one or more relays of the on-board charger, when it is determined to be the AC charging.

The AC charging may be performed using a DC output for charging generated by the on-board charger using the AC output.

The automatic connection type may be an automatic connection device-underbody (ACD-U) type.

The relay of the junction box and the relay of the on-board charger may maintain an open state when not charging (during non-charging).

An embodiment of the present disclosure can allow an automatic connection type such as an automatic connection device-underbody (ACD-U) to be efficiently applied to an already widely used manual connection type so that a vehicle may be charged by itself without person intervention.

An embodiment of the present disclosure can secure compatibility with an existing charging infrastructure by using interchangeably the existing combined charging system (CCS) and North American charging standard (NACS) types.

An embodiment of the present disclosure can perform charging by distinguishing AC/DC charging methods even when an automatic charging connection method is applied.

### BRIEF DESCRIPTION OF THE DRAWINGS

FIG. 1 is a block diagram of a configuration of an electric vehicle charging system according to an embodiment of the present disclosure.

FIG. 2 is a block diagram of a configuration of a vehicle charging apparatus configured in an electric vehicle shown in FIG. 1, according to an embodiment of the present disclosure.

FIG. 3 is a block diagram of a detailed configuration of a Y junction box, a junction box, and an on-board charger shown in FIG. 2, which may be applied to a combined charging system 1 (CCS 1) type according to an embodiment of the present disclosure.

FIG. 4 is a block diagram of a detailed configuration of the Y junction box, the junction box, and the on-board charger shown in FIG. 2, which may be applied to a combined charging system 2 (CCS 2) type according to an embodiment of the present disclosure.

FIG. 5 is a block diagram of a detailed configuration of the Y junction box, the junction box, and the on-board charger shown in FIG. 2, which may be applied to a North American charging standard (NACS) type according to an embodiment of the present disclosure.

FIGS. 6 and 7 are an operational flowchart showing an example of a method of charging an electric vehicle according to an embodiment of the present disclosure.

FIG. 8 is an operational flowchart showing a charging communication sequence between a charging facility, a ground unit, a vehicle unit, and a vehicle according to an embodiment of the present disclosure.

### DETAILED DESCRIPTION OF ILLUSTRATIVE EMBODIMENTS

The above-described features and advantages will be described below in detail with reference to the accompanying drawings for example embodiments, and thus those skilled in the art to which the present disclosure pertains can carry out the technical spirit of the present disclosure. In describing example embodiments of the present disclosure, when it is determined that a detailed description of known technology related to the present disclosure may unnecessarily obscure the gist of the present disclosure, a detailed description thereof can be omitted.

Hereinafter, example embodiments of the present disclosure will be described in detail with reference to the accompanying drawings. In the drawings, same reference numerals can be used to denote same or similar components.

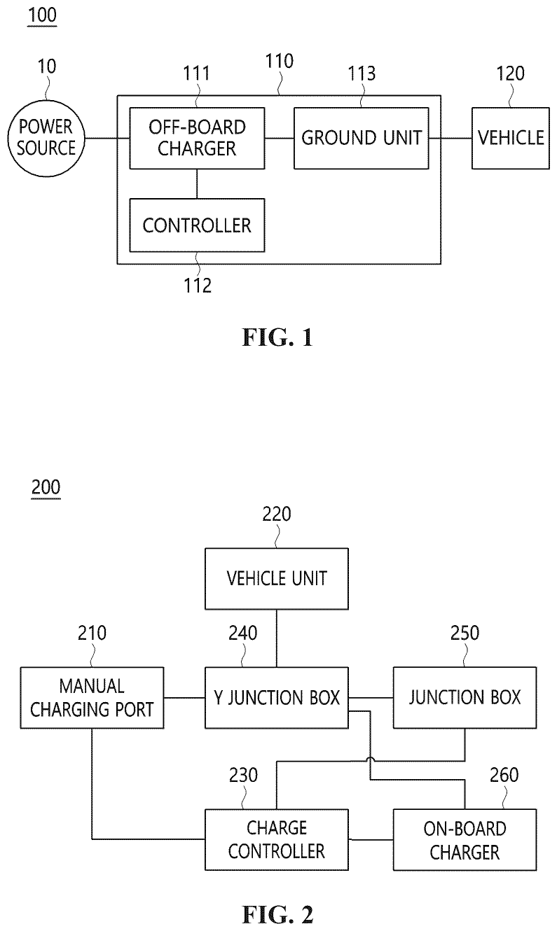

FIG. 1 is a block diagram of a configuration of an electric vehicle charging system 100 according to an embodiment of the present disclosure.

Referring to FIG. 1, the electric vehicle charging system 100 may include a charging facility 110 for receiving power from a power source 10 and providing charging power, a vehicle 120 for receiving the charging power from the charging facility 110, etc., any combination of or all of which may be in plural or may include plural components thereof. For example, the power source 10 may be an AC grid, and the vehicle 120 may be an electric vehicle.

The charging facility 110 may be electric vehicle charging equipment (EVSE). Therefore, the charging facility 110 may include an off-board charger 111, a controller 112, etc. For example, the charging facility 110 may include a ground unit (GU) 113 for supporting an automatic connection device-underbody (ACD-U) type automatic connection type.

The off-board charger 111 may serve to receive AC power from the power source 10, convert the same into charging power, and supplying the charging power to a vehicle. The off-board charger 111 may be a bidirectional charger. A rectifier, a DC power supply, etc., may be configured in the off-board charger 111.

The controller 112 may serve to control the off-board charger 111. The controller 112 may include a microprocessor, a microcomputer, a communication circuit, a memory, a display, and an input device, any combination of or all of which may be in plural or may include plural components thereof. The display may be a touch screen, etc., for example. Therefore, both an input device and an output device can be possible. The input device may include a button, a microphone, etc., for example.

The ground unit 113 may be physically connected to the off-board charger 111 and connected by being docked to a vehicle unit (VU) that is mounted at the bottom of the vehicle 120 to serve as an existing manual charging port (side/front inlets) when charging is performed by an automatic connection type, for example.

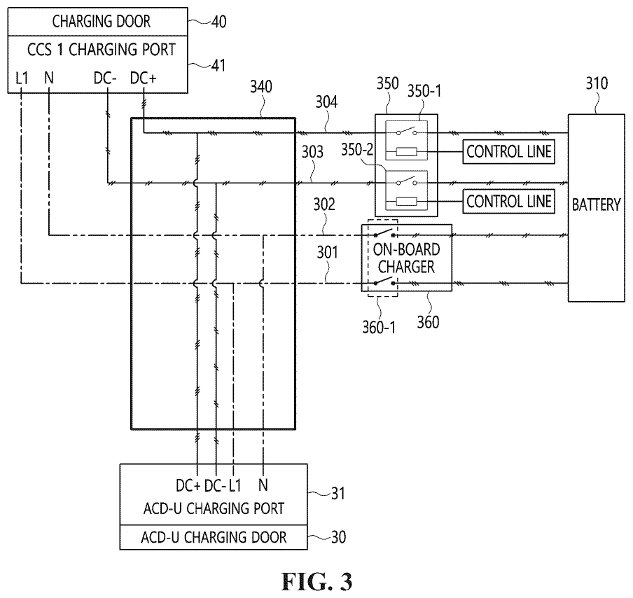

FIG. 2 is a block diagram of a configuration of a vehicle charging apparatus 200 configured in an electric vehicle shown in FIG. 1.

Referring to FIG. 2, the vehicle charging apparatus 200 may include a manual charging port 210, a vehicle unit (VU) 220, a charge controller 230, a Y junction box 240, a junction box 250, and an on-board charger 260, any combination of or all of which may be in plural or may include plural components thereof.

The manual charging port 210 may be connected to a charging connector of the charging facility 110 to serve to transmit charging power and/or control signals. The manual charging port 210 may be composed of a charging port of a combined charging system 1 (CCS 1) type, a charging port of a combined charging system 2 (CCS 2) type, and/or a charging port of a NACS type, for example. The manual charging port 210 may have different shapes depending on a slow charging method and/or a fast charging method.

The manual charging port 210 may be provided with several pins (not shown) formed on a charging connector of the charging facility 110 and several terminals (not shown) fastened thereto. The pins and the terminals may be formed differently depending on the configuration, such as CCS 1 type, the CCS 2 type, or the NACS type.

Although not explicitly shown in FIG. 2, a detection block that can serve to detect whether a charging connector (not shown) is correctly connected to a manual charging port 210 and generate a detection signal may be provided. That is, when the charging connector is not properly connected to the manual charging port 210, the detection block may serve to detect the same and transmit the detection signal to the charge controller 230.

The detection block may be implemented in a manner that uses a distance difference between the charging connector and the manual charging port 210 using a proximity sensor, an infrared sensor, etc., for example. Alternatively, the detection block may be implemented in a manner that detects a current voltage that flows minutely as the charging connector and the manual charging port 210 are connected using a current sensor, a voltage sensor, etc., for example.

The vehicle unit 220 may be a unit installed in the vehicle to charge a battery of the vehicle in an ACD-U type automatic charging method and mounted at the bottom of the vehicle to serve as the existing manual charging port (side/front inlets). In this case, the vehicle unit 220 may be connected by being docked to the ground unit installed in the charging facility.

The charge controller 230 may perform charging control by DC charging and/or AC charging.

For example, the charge controller 230 may determine the DC charging or AC charging using a signal received through a control pilot (CP), proximity detection (PD), and/or a ground (GND) line. For example, the charge controller 230 may select the DC charging or the AC charging using a CP duty.

For example, the charge controller 230 may perform charging control in the CCS 1 type, the CCS 2 type, or the NACS type according to the detection signal. That is, the charge controller 230 may control the junction box 250 and/or the on-board charger 260 depending on whether the manual charging port 210 is used for the CCS 1 type, the CCS 2 type, or the NACS type. The charge controller 230 may include a microcomputer, a microprocessor, an electronic circuit, a communication circuit, a memory, etc., any combination of or all of which may be in plural or may include plural components thereof.

The memory (storage medium) may be configured in any combination of non-volatile memories, such as a solid state disk (SSD), a hard disk drive, a flash memory, an electrically erasable programmable read-only memory (EEPROM), a static RAM (SRAM), a ferro-electric RAM (FRAM), a phase-change RAM (PRAM), and a magnetic RAM (MRAM) and/or volatile memories, such as a DRAM, a synchronous DRAM (SDRAM), and a double data rate-SDRAM (DDR-SDRAM).

The Y junction box 240 can provide a connection between at least one of charging lines of the manual connection type such as the CCS 1 type, the CCS 2 type, or the NACS type and at least one of charging lines of the automatic connection type such as the ACD-U. That is, the Y junction box 240 can connect at least one of charging lines of the manual connection type to at least one of charging lines of the automatic connection type.

The junction box 250 can serve to supply DC power to the battery or block the same to be supplied to the battery. For example, the junction box 250 may receive a DC output of the Y junction box 240.

The on-board charger 260 can serve to receive AC power and convert the same into DC power for charging. Generally, charging of electric vehicles can be classified into slow charging and fast charging. The slow charging can be a method of charging a battery by converting about 20 V AC power into DC power for charging. For example, the on-board charger 260 may receive an AC output of the Y junction box.

In contrast, the fast charging can be a method of charging a battery directly using a high DC voltage without undergoing the on-board charger 260. The on-board charger 260 may include a power factor correction (PFC), an AC-DC converter, a rectifier, etc., for example.

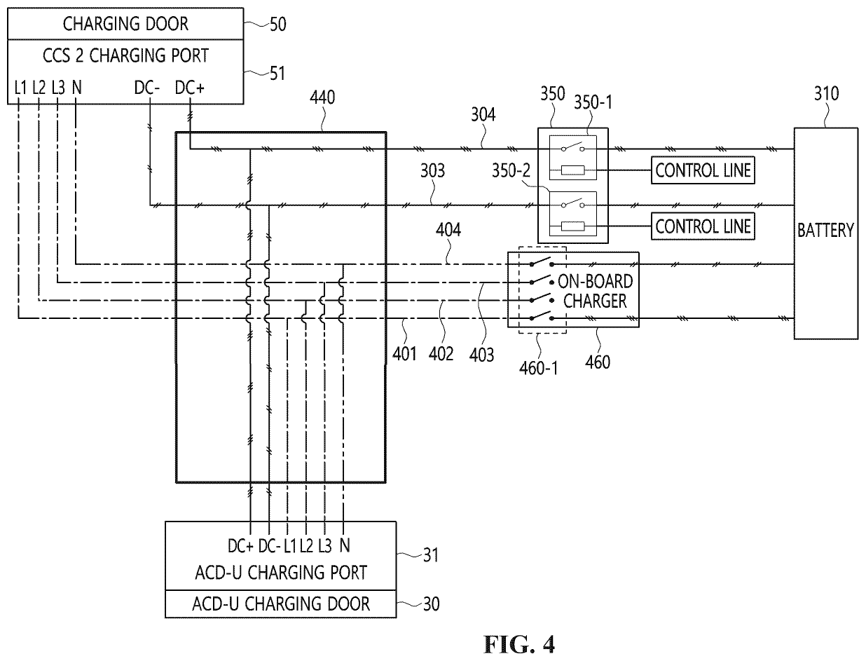

FIG. 3 is a block diagram of a detailed configuration of a Y junction box, a junction box, and an on-board charger shown in FIG. 2, which may be applied to a combined charging system 1 (CCS 1) type.

Referring to FIGS. 2 and 3, the Y junction box 340 can connect an L1 line of a CSS 1 charging port 41 corresponding to the manual charging port 210 to an L1 line of an ACD-U charging port 31 corresponding to the vehicle unit 220 of the ACD-U method, connect an N line of the CSS 1 charging port 41 to an N line of the ACD-U charging port 31, connect a DC-line of the CSS 1 charging port 41 to a DC-line of the ACD-U charging port 31, and connect a DC+line of the CSS 1 charging port 41 to a DC+ line of the ACD-U charging port 31.

For example, a charging door 40 and the CCS 1 charging port 41 may be installed on a front or side of the vehicle.

For example, the ACD-U charging door 30 and the ACD-U charging port 31 may be installed at the bottom of the vehicle.

The L1 line of the CSS 1 charging port 41 and the L1 line of the ACD-U charging port 31 can be connected together and together can be connected to an AC output line 301, the N line of the CSS 1 charging port 41 and the N line of the ACD-U charging port 31 can be connected together and together can be connected to an AC output line 302, and the AC output lines 301 and 302 may correspond to an AC output of the Y junction box 340.

The DC-line of the CSS 1 charging port 41 and the DC-line of the ACD-U charging port 31 can be connected together and together can be connected to a DC output line 303, the DC+ line of the CSS 1 charging port 41 and the DC+ line of the ACD-U charging port 31 can be connected together and together can be connected to a DC output line 304, and the DC output lines 303 and 304 may correspond to a DC output of the Y junction box 340.

The CSS 1 charging port 41 may be connected to the charging connector through the charging door 40, and the ACD-U charging port 31 may be connected to the ground unit through the ACD-U charging door 30.

For example, although not explicitly shown in FIG. 3, the CP, PD, and GND lines may be connected to the charge controller 230 through the charging door 40 and the CCS 1 charging port 41. For example, the CP, PD, and GND lines may be connected to the charge controller 230 through the ACD-U charging door 30 and the ACD-U charging port 31. The charge controller 230 may select the DC charging or the AC charging through the CP duty and information obtained by communicating with the vehicle.

Types that can be generally applied to the charging connector and the charging port are shown in the following table.

TABLE 1

| | |
|---|---|
| L1 | AC Power |
| L2/N | AC Power |
| CP | Control Pilot |
| PD | Proximity Detection |
| PE | Ground |
| DC+ | Power supply (+) |
| DC− | Power supply (−) |

In the Y junction box 340, at least one of the charging lines of the manual connection type exemplified as the CCS 1 and at least one of the charging lines of the automatic connection type exemplified as the ACD-U can be connected. In the example shown in FIG. 3, in the Y junction box 340, the charging lines L1, N, DC−, and DC+ of the manual connection type exemplified as the CCS 1 and the charging lines L1, N, DC−, and DC+ of the automatic connection type exemplified as the ACD-U can be connected. That is, the Y junction box 340 may connect the L1 line of the CCS 1 to the L1 line of the ACD-U, connect the N line of the CCS 1 to the N line of the ACD-U, connect the DC− line of the CCS 1 to the DC− line of the ACD-U, and connect the DC+ line of the CCS 1 to the DC+ line of the ACD-U. For example, the Y junction box 340 may be composed of a DC Y junction box that provides a DC output and an AC Y junction box that provides an AC output. For example, the DC Y junction box may be a part that generates the DC output through the DC output lines 303 and 304 corresponding to the DC− line and the DC+ line, and the AC Y junction box may be a part that generates the AC output through the AC output lines 301 and 302 corresponding to the L1 line and the N line.

Considering packaging in the vehicle, the Y junction box 340 may be integrated into the battery 310 or the on-board charger 360, for example.

As described above, the AC output lines 301 and 302 corresponding to the L1 line and the N line may correspond to the AC output of the Y junction box 340, and the DC output lines 303 and 304 corresponding to the DC− line and the DC+ line may correspond to the DC output of the Y junction box 340.

The junction box 350 can receive the DC output of the Y junction box 340, and the on-board charger 360 can receive the AC output of the Y junction box 340. That is, the DC output lines 303 and 304 can be connected to the junction box 350, and the AC output lines 301 and 302 can be connected to the on-board charger 360.

The junction box 350 may perform DC charging for the battery 310 using the DC output.

The on-board charger 360 may generate a DC output for charging for charging the battery 310 using the AC output for AC charging.

That is, the AC outputs provided through the AC output lines 301 and 302 may be converted into DC powers through the on-board charger 360 and connected to the high-voltage battery 310, and the DC outputs provided through the DC output lines 303 and 304 may be connected to the high-voltage battery 310 through the junction box 350.

The battery 310 may be charged in one or more of the DC charging or the AC charging.

The junction box 350 may include relays 350-1 and 350-2, and the on-board charger 360 may include relays 360-1.

During the DC charging, the relays 350-1 and 350-2 of the junction box 350 may be closed, and the relays 360-1 of the on-board charger 360 may be open.

During the AC charging, the relays 350-1 and 350-2 of the junction box 350 may be open, and the relays 360-1 of the on-board charger 360 may be closed.

That is, operating conditions of the relays 350-1 and 350-2 of the junction box 350 and the relays 360-1 of the on-board charger 360 can be as follows.

TABLE 2

| RELAY | DC charging | AC charging |
|---|---|---|
| On-board | OPEN | CLOSED |
| charger | | |
| Junction box | CLOSED | OPEN |

For example, the relays 350-1 and 350-2 of the junction box 350 and the relays 360-1 of the on-board charger 360 may be kept in an open state when not charging.

The junction box 350 can be disposed between the Y junction box 340 and the battery 310 and serve to supply DC power to the battery 310 or block the supply of the DC power thereto. The relays 350-1 and 350-2 of the junction box 350 may be junction switching elements, in which the relay 350-1 can be connected to the DC output line 304 and the relay 350-2 can be connected to the DC output line 303.

The on-board charger 360 can be disposed between the Y junction box 340 and the battery 310 and generate a DC charging output for charging the battery 310 from an AC current. The relays 360-1 of the on-board charger 360 may be junction switching elements, and the relays 360-1 may be connected to the AC output line 301 and the AC output line 302.

For example, each of the relays 350-1 and 350-2 may be a power relay and may be composed of a contact portion and a coil that operates the contact portion.

For example, the relays 350-1 and 350-2 may include semiconductor switching elements such as a field effect transistor (FET), a metal oxide semiconductor FET (MOSFET), an insulated gate bipolar mode transistor (IGBT), and a power rectifier diode, a thyristor, a gate turn-off (GTO) thyristor, and a triode for alternating current (TRIAC), a silicon controlled rectifier (SCR), IC circuits, etc.

Likewise, the relays 360-1 may include semiconductor switching elements such as a field effect transistor (FET), a metal oxide semiconductor FET (MOSFET), an insulated gate bipolar mode transistor (IGBT), and a power rectifier diode, a thyristor, a gate turn-off (GTO) thyristor, and a triode for alternating current (TRIAC), a silicon controlled rectifier (SCR), IC circuits, etc., for example.

In particular, as the semiconductor element, bipolar or power MOSFET elements, etc. may be used. The power MOSFET elements can operate at high voltage and high current and unlike most general MOSFETs, can have a double-diffused metal oxide semiconductor (DMOS) structure.

Each of the relays 350-1 and 350-2 may be connected to the charge controller 230 through a control line. Therefore, the relays 350-1 and 350-2 may perform a closed operation or an open operation according to an on/off signal of the charge controller 230.

Likewise, the relays 360-1 may be connected to the charge controller 230 through the control line. Therefore, the relays 360-1 may perform a closed operation or an open operation according to the on/off signal of the charge controller 230.

The battery 310 can include battery cells (not shown) configured in series and/or parallel, and the battery cells may be high-voltage battery cells for electric vehicles, such as nickel metal battery cells, lithium ion battery cells, lithium polymer battery cells, lithium sulfur battery cells, sodium sulfur battery cells, and all-solid-state battery cells. In general, a high-voltage battery can indicate a battery used as a power source for moving electric vehicles and can have a high voltage of 100 V or more, for example. However, the present disclosure is not necessarily limited thereto, and low-voltage batteries can be also possible.

The battery 310 may include a battery management system (BMS). The BMS can serve to increase energy efficiency and extend lifetime by optimizing management of an electric vehicle battery. It can be possible to increase the stability and reliability of the battery by monitoring a voltage, current, and temperature of the battery in real time and preventing excessive charging and discharging.

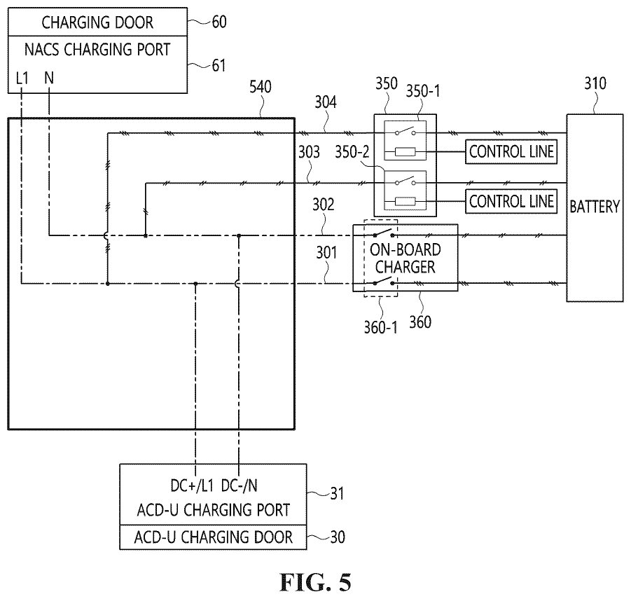

FIG. 4 is a block diagram of a detailed configuration of the Y junction box, the junction box, and the on-board charger shown in FIG. 2, which may be applied to a CCS 2 method.

Referring to FIGS. 2 and 4, a Y junction box 440 can connect an L1 line of a CSS 2 charging port 51 corresponding to the manual charging port 210 to the L1 line of the ACD-U charging port 31 corresponding to the vehicle unit 220 of the ACD-U method, connect an N2 line of the CSS 2 charging port 51 to an N2 line of the ACD-U charging port 31, connect an L3 line of the CSS 2 charging port 51 to an L3 of the ACD-U charging port 31, connect an N line of the CSS 2 charging port 51 to the N line of the ACD-U charging port 31, connect a DC-line of the CSS 2 charging port 51 to the DC− line of the ACD-U charging port 31, and connect a DC+ line of the CSS 2 charging port 51 to the DC+ line of the ACD-U charging port 31.

For example, a charging door 50 and the CCS 2 charging port 51 may be installed on a front or side of the vehicle.

For example, the ACD-U charging door 30 and the ACD-U charging port 31 may be installed at the bottom of the vehicle.

The L1 line of the CSS 2 charging port 51 and the L1 line of the ACD-U charging port 31 can be connected together and together can be connected to an AC output line 401, the L2 line of the CSS 2 charging port 51 and the L2 line of the ACD-U charging port 31 can be connected together and together can be connected an AC output line 402, the L3 line of the CSS 2 charging port 51 and the L3 line of the ACD-U charging port 31 can be connected together and together can be connected to the AC output line 403, the N line of the CSS 2 charging port 51 and the N line of the ACD-U charging port 31 can be connected together and together can be connected to an AC output line 404, and the AC output lines 401, 402, 403, and 404 may correspond to the AC outputs.

The DC-line of the CSS 2 charging port 51 and the DC− line of the ACD-U charging port 31 can be connected together and together can be connected to a DC output line 303, the DC+ line of the CSS 2 charging port 51 and the DC+ line of the ACD-U charging port 31 can be connected together and together can be connected to a DC output line 304, and the DC output lines 303 and 304 may correspond to a DC output of the Y junction box 440.

The CSS 2 charging port 51 may be connected to the charging connector through the charging door 50, and the ACD-U charging port 31 may be connected to the ground unit through the ACD-U charging door 30.

For example, although not explicitly shown in FIG. 4, the CP, PD, and GND lines may be connected to the charge controller 230 through the charging door 50 and the CCS 2 charging port 51. For example, the CP, PD, and GND lines may be connected to the charge controller 230 through the ACD-U charging door 30 and the ACD-U charging port 31. The charge controller 230 may select the DC charging or the AC charging through the CP duty and information obtained by communicating with the vehicle.

In the Y junction box 440, at least one of the charging lines of the manual connection type exemplified as the CCS 2 and at least one of the charging lines of the automatic connection type exemplified as the ACD-U can be connected. In the example shown in FIG. 4, in the Y junction box 440, the charging lines L1, L2, L3, N, DC−, and DC+ of the manual connection type exemplified as the CCS 2 and the charging lines L1, L2, L1, N, DC−, and DC+ of the automatic connection type exemplified as the ACD-U can be connected. That is, the Y junction box 440 may connect the L1 line of the CCS 2 to the L1 line of the ACD-U, connect the L2 line of the CCS 2 to the L2 line of the ACD-U, connect the L3 line of the CCS 2 to the L3 line of the ACD-U, connect the N line of the CCS 2 to the N line of the ACD-U, connect the DC− line of the CCS 2 to the DC-line of the ACD-U, and connect the DC+ line of the CCS 2 to the DC+line of the ACD-U. For example, the Y junction box 440 may be composed of a DC Y junction box that provides a DC output and an AC Y junction box that provides an AC output. For example, the DC Y junction box may be a part that generates the DC output through the DC output lines 303 and 304 corresponding to the DC− line and the DC+ line, and the AC Y junction box may be a part that generates the AC output through the AC output lines 401, 402, 403 and 404 corresponding to the L1 line, the L2 line, the L3 line, and the N line.

Considering packaging in the vehicle, the Y junction box 440 may be integrated into the battery 310 or the on-board charger 460, for example.

As described above, the AC output lines 401, 402, 403, and 404 corresponding to the L1 line, the L2 line, the L3 line, and the N line may correspond to the AC output of the Y junction box 440, and the DC output lines 303 and 304 corresponding to the DC− line and the DC+ line may correspond to the DC output of the Y junction box 440.

The junction box 350 and the battery 310 have already been sufficiently described through the example of FIG. 3, and thus will not be described again.

The on-board charger 460 may receive the AC output of the Y junction box 440. That is, the DC output lines 303 and 304 can be connected to the junction box 350, and the AC output lines 401, 402, 403, and 404 can be connected to the on-board charger 460.

The on-board charger 460 may generate a DC output for charging for charging the battery 310 using the AC output for AC charging.

That is, the AC outputs provided through the AC output lines 401, 402, 403, and 404 may be converted into DC powers through the on-board charger 460 and connected to the high-voltage battery 310.

The on-board charger 460 may include relays 460-1.

During the DC charging, the relays 350-1 and 350-2 of the junction box 350 may be closed, and the relays 460-1 of the on-board charger 460 may be open.

During the AC charging, the relays 350-1 and 350-2 of the junction box 350 may be open, and the relays 460-1 of the on-board charger 460 may be closed.

For example, the relays 350-1 and 350-2 of the junction box 350 and the relays 460-1 of the on-board charger 460 may be kept in an open state when not charging.

The on-board charger 460 can be disposed between the Y junction box 440 and the battery 310 and generate a DC charging output for charging the battery 310 from an AC current. The relays 460-1 of the on-board charger 460 may be junction switching elements, and the relays 460-1 may be connected to the AC output line 401, the AC output line 403, and the AC output line 404.

For example, the relays 460-1 may each be a power relay and may be implemented as semiconductor switching elements such as a field effect transistor (FET), a metal oxide semiconductor FET (MOSFET), an insulated gate bipolar mode transistor (IGBT), and a power rectifier diode, a thyristor, a gate turn-off (GTO) thyristor, and a triode for alternating current (TRIAC), a silicon controlled rectifier (SCR), IC circuits, etc.

In particular, as the semiconductor element, bipolar or power MOSFET elements, etc. may be used. The power MOSFET elements can operate at high voltage and high current and unlike most general MOSFETs, and can have a double-diffused metal oxide semiconductor (DMOS) structure.

For example, the relays 460-1 may be connected to the charge controller 230 through a control line. Therefore, the relays 460-1 may perform a closed operation or an open operation according to the on/off signal of the charge controller 230.

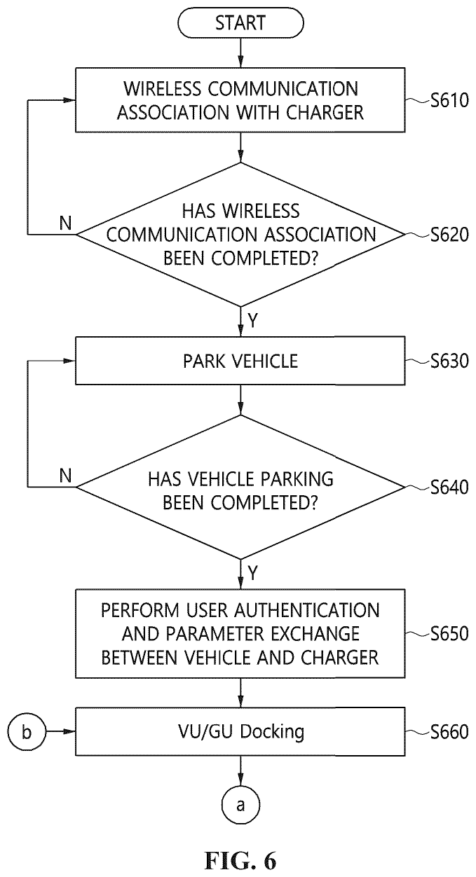

FIG. 5 is a block diagram of a detailed configuration of the Y junction box, the junction box, and the on-board charger shown in FIG. 2, which may be applied to a North American charging standard (NACS) type.

Referring to FIGS. 2 and 5, a Y junction box 540 can connect an L1 line of a NACS charging port 61 corresponding to the manual charging port 210 to the DC+/L1 line of the ACD-U charging port 31 corresponding to the vehicle unit 220 of the ACD-U method and connect an N line of the NACS charging port 61 to the DC−/N line of the ACD-U charging port 31.

In particular, a DC+ line of the NACS charging port 61 may be used in common with the L1 line, and a DC− line thereof may be used in common with the N line.

For example, a charging door 60 and the NACS charging port 61 may be installed on a front or side of the vehicle.

For example, the ACD-U charging door 30 and the ACD-U charging port 31 may be installed at the bottom of the vehicle.

The L1 line of the NACS charging port 61 and the DC+/L1 line of the ACD-U charging port 31 can be connected together and together can be connected to the AC output line 301 and the DC output line 304, the N line of the NACS charging port 61 and the DC−/N line of the ACD-U charging port 31 can be connected together and together can be connected to the AC output line 302 and the DC output line 303, the AC output lines 301 and 302 may correspond to the AC output of the Y junction box 540, and the DC output lines 303 and 304 may correspond to the DC output of the Y junction box 540.

That is, in the example shown in FIG. 5, the DC output lines and the AC output lines may share the same lines, and appropriate lines may be switched for DC charging and AC charging based on the relays of the junction box 350 and the on-board charger 360.

For example, although not explicitly shown in FIG. 5, the CP, PD, and GND lines may be connected to the charge controller 230 through the charging door 60 and the NACS charging port 61. For example, the CP, PD, and GND lines may be connected to the charge controller 230 through the ACD-U charging door 30 and the ACD-U charging port 31. The charge controller 230 may select the DC charging or the AC charging through the CP duty and information obtained by communicating with the vehicle.

In the Y junction box 540, at least one of the charging lines of the manual connection type exemplified as the NACS and at least one of the charging lines of the automatic connection type exemplified as the ACD-U can be connected. In the example shown in FIG. 5, in the Y junction box 540, the charging lines L1 and N of the manual connection type exemplified as the NACS and the charging lines DC+/L1 and DC−/N of the automatic connection type exemplified as the ACD-U can be connected. That is, the Y junction box 540 may connect the L1 line of the NACS to the DC+/L1 line of the ACD-U and connect the N line of the NACS to the DC−/N line of the ACD-U. For example, the Y junction box 540 may be composed of a DC Y junction box that provides a DC output and an AC Y junction box that provides an AC output. For example, the DC Y junction box may be a part that generates DC outputs through the DC output lines 303 and 304, and the AC Y junction box may be a part that generates AC outputs through the AC output lines 301 and 302.

Considering packaging in the vehicle, the Y junction box 540 may be integrated into the battery 310 or the on-board charger 360, for example.

The junction box 350, the on-board charger 360, and the battery 310 have already been sufficiently described through the example of FIG. 3, and thus will not be described again.

However, in the embodiment shown in FIG. 5, because the AC output and DC output of the Y junction box 540 share a line, an input side of the on-board charger 360 should satisfy withstanding voltage conditions during DC charging, and an input circuit therefor may be additionally provided.

As can be seen through the example embodiments shown in FIGS. 3, 4, and 5, by adding the Y junction box to a vehicle to which the existing manual connection type such as the CCS 1 type, the CCS 2 type, or the NACS type is applied, the charging of the ACD-U type automatic connection type can be used efficiently.

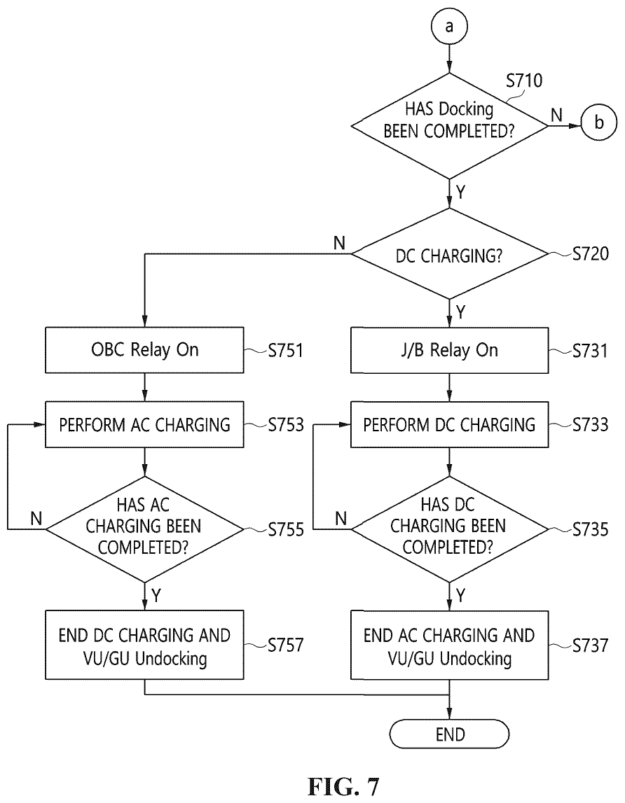

FIGS. 6 and 7 are an operational flowchart showing an example of a method of charging an electric vehicle according to an embodiment of the present disclosure.

Referring to FIG. 6, an electric vehicle charging method according to an embodiment of the present disclosure can perform wireless communication association between a vehicle and a charger (operation S610).

For example, various technologies introduced for communication between an electric vehicle and a charging infrastructure may be used for the wireless communication association, and for example, a wireless LAN (WLAN) technology such as 801.1 in or Wi-Fi may be used.

The electric vehicle charging method according to an embodiment of the present disclosure can determine whether the wireless communication association has been completed (operation S620).

When the wireless communication association is not completed as a result of the determination in operation (operation S620), the process can return to operation S610 to perform wireless communication association.

When the wireless communication association is completed as a result of the determination in operation (operation S620), the vehicle can be parked so that the vehicle may be located within a range in which docking for automatic connection charging can be possible (operation S630).

For example, in the case of the ACD-U method, the vehicle may be parked at a location where the ground unit GU and the vehicle unit VU may be docked by operation S630.

For example, the vehicle may be parked by manned parking or unmanned parking.

The electric vehicle charging method according to an embodiment of the present disclosure can determine whether the wireless communication association has been completed (operation S640).

For example, operation S640 may include determining whether the vehicle parking has been completed in consideration of a location (e.g., a P stage) of a vehicle gear and an ignition state (e.g., an ignition off).

When the vehicle parking is not completed as a result of the determination in operation S640, the process can return to operation S630 to perform vehicle parking.

When the vehicle parking is completed as a result of the determination in operation S640, user authentication and parameter exchange between the vehicle and the charger can be performed (operation S650).

In operation S650, plug and charge (PnC) type authentication may be used for user authentication, for example.

Through operation S650, the vehicle may check whether the charger is an AC charger or a DC charger, and information about maximum charging power/voltage/current, a current state of charge (SOC), a target SOC, a departure time, etc. may be exchanged between the vehicle and the charger.

The electric vehicle charging method according to an embodiment of the present disclosure can include docking the vehicle unit and the ground unit (operation S660).

That is, in operation S660, the vehicle unit VU and the ground unit GU of the ACD-U method may be automatically docked.

For example, operation S660 may include performing docking based on the number of preset docking retries and when the docking fails because the number of docking retries is exceeded, ending the procedure after final failure processing.

Referring to FIG. 7, the electric vehicle charging method according to an embodiment of the present disclosure can include determining whether the docking has been completed (operation S710).

When the docking is not completed as a result of the determination in operation S710, the process can return to operation S660 to perform docking.

When the docking is completed as a result of the determining in operation S710, the electric vehicle charging method according to an embodiment of the present disclosure can include determining whether it is DC charging or AC charging (operation S720).

For example, operation S720 may be performed by the charge controller 230 shown in FIG. 2. That is, the charge controller 230 may determine whether it is DC charging or AC charging when the docking of the automatic connection type is completed.

As a result of the determination in operation S720, when it is determined to be the DC charging, the electric vehicle charging method according to an embodiment of the present disclosure can include closing the relays of the junction box that receives the DC output of the Y junction box (operation S731).

Operation S731 may include opening the relays of the on-board charger that receives the AC output of the Y junction box.

The relay of the junction box and the relay of the on-board charger may maintain the open state when not charging.

When operation S731 is performed, the electric vehicle charging method according to an embodiment of the present disclosure can include performing DC charging (operation S733).

The electric vehicle charging method according to an embodiment of the present disclosure can include determining whether the DC charging has been completed (operation S735).

As a result of the determination in operation S735, when the DC charging is not completed, the electric vehicle charging method according to an embodiment of the present disclosure can return to operation S733 to continuously perform DC charging.

As a result of the determination in operation S735, when the DC charging is completed, the electric vehicle charging method according to an embodiment of the present disclosure can include ending the DC charging and releasing the docking between the ground unit and the vehicle unit (operation S737).

As a result of the determination in operation S720, when it is determined to be the AC charging, the electric vehicle charging method according to an embodiment of the present disclosure can include closing the relays of the on-board charger that receives the AC output of the Y junction box (operation S751).

When the relays of the on-board charger are closed, the on-board charger may generate the DC output for charging the battery from the AC output.

Operation S751 may include opening the relays of the junction box that receives the DC output of the Y junction box.

The relay of the junction box and the relay of the on-board charger may maintain the open state when not charging.

When operation S751 is performed, the electric vehicle charging method according to an embodiment of the present disclosure can include performing AC charging (operation S753).

The AC charging may be performed using the DC output for charging generated by the on-board charger using the AC output.

The electric vehicle charging method according to an embodiment of the present disclosure can include determining whether the AC charging has been completed (operation S755).

As a result of the determination in operation S755, when the AC charging is not completed, the electric vehicle charging method according to an embodiment of the present disclosure can returns to operation S753 to continuously perform AC charging.

As a result of the determination in operation S755, when the AC charging is completed, the electric vehicle charging method according to an embodiment of the present disclosure can include ending the AC charging and releasing the docking between the ground unit and the vehicle unit (operation S757).

Each operation shown in FIGS. 6 and 7 may be performed by the charge controller 230 shown in FIG. 2, performed in the order shown in FIGS. 6 and 7, the reverse order, or the third order, and performed simultaneously.

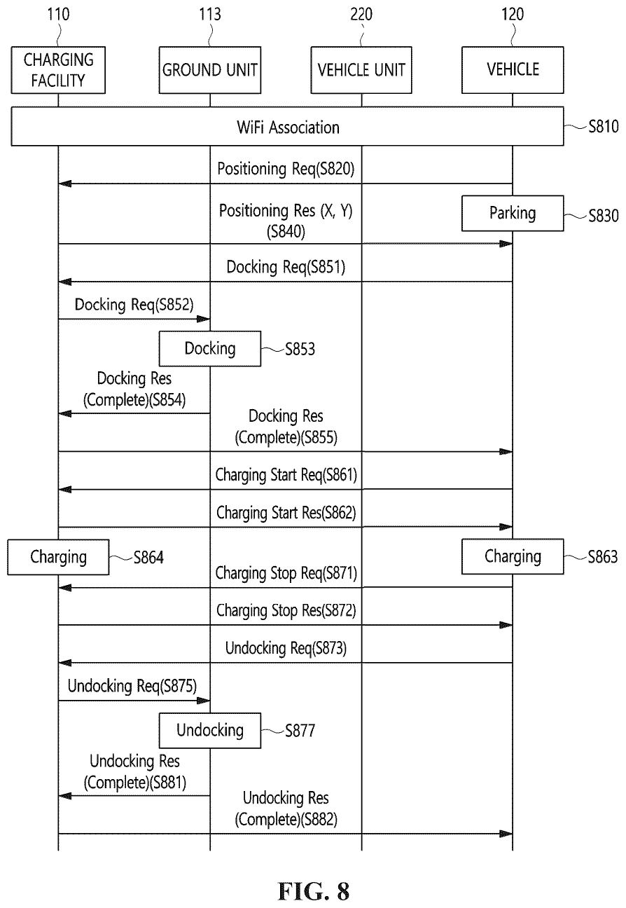

FIG. 8 is an operational flowchart showing a charging communication sequence between a charging facility, a ground unit, a vehicle unit, and a vehicle according to an embodiment of the present disclosure.

Referring to FIG. 8, first, wireless communication association can be performed (operation S810).

For example, the wireless communication association may be performed between the charging facility 110 and the vehicle 120, and at least one of the ground unit 113 and the vehicle unit 220 may participate.

For example, the charging facility 110 may be a charging facility of the ACD-U type automatic connection type.

The vehicle 120 can transmit positioning request to the charging facility 110 (operation S820) and perform parking (operation S830).

The charging facility 110 that receives the positioning request can provide a result of the positioning to the vehicle 120 (operation S840).

The vehicle 120 can determine whether parking has been completed in a docking-capable state based on a result of the positioning and when it is determined that docking is possible, can transmit the docking request to the charging facility 110 (operation S851).

The charging facility 110 receiving the docking request can transmit the docking request to the ground unit 113 (operation S852).

The ground unit receiving the docking request can perform docking with the vehicle unit (operation S853).

When the docking is completed, the ground unit can transmit a docking completion response to the charging facility 110 (operation S854), and the charging facility receiving the same can transmit the docking completion response to the vehicle 120 (operation S855).

The vehicle 120 receiving the docking completion response can transmit charging start request to the charging facility 110 (operation S861), and the charging facility 110 receiving the same can transmit the charging start response to the vehicle 120 (operation S862).

The vehicle 120 and the charging facility 110 that have received the charging start response can perform charging (operations S863 and S864).

When charging is completed, the vehicle 120 can transmit charging end request to the charging facility 110 (operation S871), and the charging facility 110 receiving the same can transmit the charging end response to the vehicle 120 (operation S872).

The vehicle 120 receiving the charging end response can transmit an undocking request to the charging facility 110 (operation S873), and the charging facility 110 receiving the same can transmit the undocking request to the ground unit 113 (operation S875).

The ground unit 113 receiving the undocking request can be undocked from the vehicle unit 220 (operation S877).

When undocked, the ground unit 113 can transmit an undocking completion response to the charging facility 110 (operation S881), and the ground unit 113 receiving the same can transmit the undocking completion response to the vehicle 120 (operation S882).

The operations of the method or algorithm described in relation to the example embodiments disclosed herein may be implemented in the form of program commands that may be executed through various computer devices such as a microprocessor, a processor, and a CPU and stored in a computer-readable medium. The computer-readable medium may include program (command) codes, data files, data structures, etc. alone or in combination.

What is claimed is:

1. An electric vehicle charging apparatus comprising:
a Y junction box configured to provide a connection between at least one of first charging lines of a manual connection type and at least one of second charging lines of an automatic connection type;
a direct current (DC) junction box configured to receive a DC output of the Y junction box; and
an on-board charger configured to receive an alternating current (AC) output of the Y junction box.

2. The apparatus of claim 1, wherein the automatic connection type is an automatic connection device-underbody (ACD-U) type.

3. The apparatus of claim 1, wherein the Y junction box comprises:
a DC Y junction box configured to provide the DC output; and
an AC Y junction box configured to provide the AC output.

4. The apparatus of claim 1, further comprising a charge controller configured to perform charging control using one or more of DC charging or AC charging.

5. The apparatus of claim 4, further comprising a battery configured to be charged using the one or more of the DC charging or the AC charging, wherein the DC junction box is configured to perform the DC charging using the DC output, and wherein the on-board charger is configured to generate an AC-to-DC-converted DC output for charging for charging the battery using the AC output for the AC charging.

6. The apparatus of claim 5, wherein each of the DC junction box and the on-board charger includes at least one relay, wherein the DC junction box and the on-board charger are configured such that during the DC charging, the at least one relay of the DC junction box is closed and the at least one relay of the on-board charger is open, and during the AC charging, the at least one relay of the DC junction box is open and the at least one relay of the on-board charger is closed.

7. The apparatus of claim 6, wherein the at least one relay of the DC junction box and the at least one relay of the on-board charger maintain an open state in response to a charging state being not charging.

8. The apparatus of claim 2, wherein the first charging lines of the manual connection type include an L1 line, an N line, a DC− line, and a DC+ line that correspond to a combined charging system 1 (CCS 1), and
wherein the Y junction box connects the L1 line of the manual connection type to an L1 line of the ACD-U type, connects the N line of the manual connection type to an N line of the ACD-U type, connects the DC-line of the manual connection type to a DC− line of the ACD-U type, and connects the DC+ line of the manual connection type to a DC+ line of the ACD-U type.

9. The apparatus of claim 2, wherein the first charging lines of the manual connection type include an L1 line, an 12 line, an L3 line, an N line, a DC− line, and a DC+ line that correspond to a combined charging system 2 (CCS 2), and
wherein the Y junction box connects the L1 line of the manual connection type to an L1 line of the ACD-U type, connects the L2 line of the manual connection type to an L2 line of the ACD-U type, connects the L3 line of the manual connection type to an L3 line of the ACD-U type, connects the N line of the manual connection type to an N line of the ACD-U type, connects the DC− line of the manual connection type to a DC− line of the ACD-U type, and connects the DC+ line of the manual connection type to a DC+ line of the ACD-U type.

10. The apparatus of claim 2, wherein the first charging lines of the manual connection type include an L1 line and an N line that correspond to a North American charging standard (NACS), and
wherein the Y junction box connects the L1 line of the manual connection type to DC+/L1 lines of the ACD-U type and connects the N line of the manual connection type to DC−/N lines of the ACD-U type.

11. An electric vehicle charging method comprising:
determining, by a charge controller, whether a charging state is DC charging or AC charging in response to docking of an automatic connection type being completed; and
performing, by the charge controller, the DC charging of a battery by closing one or more first relays of a DC junction box receiving a DC output of a Y junction box and opening one or more second relays of an on-board charger receiving an AC output of the Y junction box, in response to the charging state being determined to be the DC charging.

12. The method of claim 11, further comprising, by the charge controller, performing the AC charging of the battery by opening the one or more first relays of the DC junction box and closing the one or more second relays of the on-board charger, in response to the charging state being determined to be the AC charging.

13. The method of claim 12, wherein the AC charging is performed using an AC-to-DC-converted DC output for charging generated by the on-board charger using the AC output of the Y junction box.

14. The method of claim 11, wherein the automatic connection type is an automatic connection device-underbody (ACD-U) type.

15. The method of claim 12, wherein the relay of the junction box and the relay of the on-board charger maintain an open state when not charging.

16. An electric vehicle charging apparatus for an electric vehicle, the electric vehicle charging apparatus comprising:
a Y junction box including:
first charging lines connected to a first charging port of a manual connection type,
second charging lines connected to a second charging port of an automatic connection type, and
third charging lines connected to Y junction box outputs, wherein the first charging lines, the second charging lines, and the third charging lines are connected together forming a set of Y nodes inside the Y junction box, wherein the Y junction box outputs include a DC output and an alternating current (AC) output, such that a DC charging current can be provided to the DC output from one of or both of the first charging port and the second charging port, and such that an AC charging current can be provided to the AC output from one of or both of the first charging port and the second charging port;
a DC junction box connected to the DC output of the Y junction box; and
an on-board charger connected to the AC output of the Y junction box.

17. The apparatus of claim 16, further comprising:
a battery connected to the DC junction box and the on-board charger; and
a charge controller configured to select and control relays for charging by the DC charging current using the DC junction box, charging by the AC charging current using the on-board charger, or not charging by disconnecting the DC output and the AC output from the battery.

18. The apparatus of claim 16, wherein the first charging lines of the manual connection type include a first L1 line, a first N line, a first DC− line, and a first DC+ line that correspond to a combined charging system 1 (CCS 1);
wherein the Y junction box connects the first L1 line coming from the first charging port to a second L1 line coming from the second charging port at a first node, connects the first N line coming from the first charging port to a second N line coming from the second charging port at a second node, connects the first DC− line coming from the first charging port to a second DC− line coming from the second charging port at a third node, and connects the first DC+ line coming from the first charging port to a second DC+ line coming from the second charging port at a fourth node;
wherein the AC output is connected to the first node and the second node; and
wherein the DC output is connected to the third node and the fourth node.

19. The apparatus of claim 16, wherein the first charging lines of the manual connection type include a first L1 line, a first L2 line, a first L3 line, a first N line, a first DC− line, and a first DC+ line that correspond to a combined charging system 2 (CCS 2); and
wherein the Y junction box connects the first L1 line coming from the first charging port to a second L1 line coming from the second charging port at a first node, connects the first L2 line coming from the first charging port to a second L2 line coming from the second charging port at a second node, connects the first L3 line coming from the first charging port to a second L3 line coming from the second charging port at a third node, connects the first N line coming from the first charging port to a second N line coming from the second charging port at a fourth node, connects the first DC− line coming from the first charging port to a second DC− line coming from the second charging port at a fifth node, and connects the first DC+ line coming from the first charging port to a second DC+ line coming from the second charging port at a sixth node;
wherein the AC output is connected to the first node, the second node, the third node, and the fourth node; and
wherein the DC output is connected to the fifth node and the sixth node.

20. The apparatus of claim 16, wherein the first charging lines of the manual connection type include a first L1 line and a first N line that correspond to a North American charging standard (NACS);
wherein the Y junction box connects the first L1 line coming from the first charging port to DC+/L1 lines coming from the second charging port at a first node, and connects the first N line coming from the first charging port to DC−/N lines coming from the second charging port at a second node;
wherein the AC output is connected to the first node and the second node; and
wherein the DC output is connected to the first node and the second node.
